(19) United States
(12) Patent Application Publication
(10) Pub. No.: US 2026/0013508 A1
(43) Pub. Date: Jan. 15, 2026

(54) BIOLOGICAL CONTROL AGENT

(71) Applicant: UNIVERSITÉ DE LIÈGE, Liège (BE)

(72) Inventors: Gilles STOUVENAKERS, Gembloux (BE); Haissam JIJAKLI, Gembloux (BE); Sébastien MASSART, Gembloux (BE)

(21) Appl. No.: 18/995,378

(22) PCT Filed: Jul. 14, 2023
(86) PCT No.: PCT/EP2023/069702

§ 371 Date: Jan. 16, 2025

(30) Foreign Application Priority Data
Jul. 20, 2022 (EP) 22186090.1

(51) Int. Cl. A01N 63/20; A01P 1/00

(52) U.S. Cl. CPC A01N 63/20; A01P 1/00

(57) ABSTRACT

The present disclosure relates to methods for treating or preventing a plant disease, biological control compositions and the use of bacteria as biological control agent. In particular, the present disclosure relates to the use of bacteria of the species Sphingobium xenophagum as a biological control agent for controlling a pest population, and more specifically for treating or preventing a disease in a plant or seed in need thereof.

### CROSS-REFERENCE TO RELATED APPLICATION(S)

This present application is a national stage application of International Patent Application No. PCT/EP2023/069702, filed Jul. 14, 2023, which claims priority to European Patent Application No. 22186090.1, filed Jul. 20, 2022, the disclosures of which are hereby incorporated by reference in their entireties.

### TECHNICAL FIELD

The present disclosure relates to methods for treating or preventing a plant disease, biological control compositions and the use of bacteria as biological control agent. In particular, the present disclosure relates to the use of bacteria of the species Sphingobium xenophagum as a biological control agent for controlling a pest population, more specifically for treating or preventing a disease in a plant or seed in need thereof.

### BACKGROUND

In modern agronomy, the major pest species have been mainly controlled by chemical agents, i.e. pesticides. Nowadays, many of the new pesticides made available on the market are more selective and less hazardous than the older compounds. However, even the newest pesticides present several major problems. These include: the development of resistance in target pest species, the dwindling supply of useful, registered synthetic pesticides, the deposition of undesirable residues, the detrimental effect on non-target species resulting is secondary pest outbreaks, the phytotoxic reactions induced in treated plants. It is therefore becoming increasingly clear that solely relying on chemical control will not be the solution to the problem of agricultural pest management. For this reason, many farmers are exploring and adopting methods to reduce pesticide use.

One alternative to the use of chemical agents is biological control. Biological control is the intentional manipulation of populations of living beneficial organisms (natural enemies) in order to limit populations of pests. Indeed, virtually all pests have natural enemies and appropriate management of such natural enemies can effectively control many pests. The objective of biological control is not to eradicate pests, but to maintain them at tolerable levels at which they do not cause appreciable damage. As such, biological control agents can be effective, economical and safe.

Since many years, biological control agents have been used in order to control pests in crops. Most of these agents were isolated from soil and are commercially used for the control of pests in soil (see e.g. Postma et al. (2008) Soilless culture: Theory and practice, Third Edit. Elsevier, pp. 425-457; Vallance et al. (2010) Agron Sustain. Dev. 31, 191-203; Montagne et al. (2017) Environ Chem Lett. 15, 537-545). However, until now, no biological control agent has specifically been developed to control plant root diseases in soilless cultures. Unfortunately, biological control agents isolated from soil often lack efficacy in protecting plants against diseases in soilless cultures. The consequence is therefore a poor adaptation of the commercial biological control agents to soilless conditions, in particular to aquatic conditions, and parameters found in soilless systems such as greenhouse structures.

In addition, the pathogens associated with the particular conditions of soilless cultures can differ widely from those typically encountered in classical soil-based agricultural systems. Indeed, some root pathogens particularly adapted to water can rapidly spread diseases in soilless cultures. This is particularly true for Oomycete pathogens which produce flagellated spores, such as Pythium aphanidermatum (Edson) Fitzp. This pathogen causes root rot disease on lettuce (Sutton et al. (2006) Summa Phytopathol. 32, 3017-321). This problem can occur in hydroponics and aquaponics. In the aquaponic system, chemical pesticides are unadvisable because of the presence of fish in the same water loop as plants (Stouvenakers et al. (2019) Aquaponics Food Production Systems. Springer, Cham. 353-378).

There is therefore a growing interest for the identification of novel biological control agents for controlling pests in crops but also adapted to soilless culture environments, in particular hydroponics and aquaponics, which are efficient but also safe for the plants to be treated, for the human operators, as well as for the environment.

Identifying new microorganisms for use as biological control agent, which are at the same time efficient and safe, remains a challenge. Until now, isolation campaigns aiming at identifying beneficial microorganisms adapted to soilless cultures failed to move to commercialization, for example because they were not able to reduce disease incidence and symptoms, had a negative impact on the treated plant, or were not user-friendly (harmful to humans or the environment).

In view of the above, there is a continuing need to obtain efficacious biological control agents for treating or preventing plant diseases, in particular in soilless cultures but also in crops, for compositions comprising such adapted for commercial uses and for better pest control, in particular in soilless cultures.

### SUMMARY

The inventors have surprisingly found that the use of bacteria from the species Sphingobium xenophagum as biological control agent for controlling a pest population overcomes the problems of the prior art.

Therefore, the present disclosure provides for the use of Sphingobium xenophagum as a biological control agent.

In another aspect of the present disclosure there is further provided a method for treating or preventing a plant disease, comprising supplying to a plant or a seed in need thereof an effective amount of Sphingobium xenophagum, and a biological control composition comprising Sphingobium xenophagum, wherein the composition is selected from the group consisting of a substrate composition, a nutrient composition and a plant control composition.

### DETAILED DESCRIPTION

As used herein and in the claims, the terms «comprising» and «including» are inclusive and open-ended and do not exclude additional unrecited elements, compositional components or method steps. Accordingly, the terms «comprising» and «including» encompass the more restrictive terms «consisting essentially of» and «consisting of».

As described herein before, the present disclosure concerns the use of Sphingobium xenophagum as a biological control agent.

By the term «biological control agent», is meant in the sense of the present disclosure, an organism for controlling a pest population, i.e. an organism that is effective in controlling a pest population. It is appreciated that by doing so, the biological control agent is environmentally safe, that is, it is detrimental to the target pest population, but does not damage other species in a non-specific manner. In other words, by the term «biological control agent», is meant in the sense of the present disclosure, a natural enemy, antagonist or competitor, or other organism, used for pest control (see the definition in the Glossary of phytosanitary terms; ISPM 3, 1995; revised ISPM 3, 2005; International Plant Protection Convention (IPPC)).

Within the context of the present disclosure, the terms «pest» and «pathogen» can be used interchangeably to refer to an organism that may invade or colonize a plant host and reduce the health, growth, vigor and/or yield of the plant. Various examples of such pests are provided herein below. More particularly, by the term «pest», is meant in the sense of the present disclosure, any species, strain or biotype of plant, animal or pathogenic agent injurious to plants or plant products (see the definition in the Glossary of phytosanitary terms; FAO, 1990; revised ISPM 2, 1995; IPPC, 1997; CPM, 2012; International Plant Protection Convention (IPPC)).

The terms «controlling» and «protecting» in relation to a pest, refer to one or more of reducing the growth, germination, reproduction and/or proliferation of a pest of interest, as well as to killing, removing, destroying or otherwise diminishing the occurrence and/or activity of a pest of interest.

The species Sphingobium xenophagum has a wide distribution and can be readily isolated from nature for use in the present disclosure. This species is also known as Sphingomonas xenophaga or Sphingobium hydrophobicum.

Preferred strains are Sphingobium xenophagum with accession number LMG No. P-32737, LMG No. P-33173 and LMG No. P-33175, described herein and deposited in accordance with the Budapest Treaty on Jun. 30, 2022 with the Belgian Coordinated Collections of Microorganisms (BCCM, K. L. Ledeganckstraat 35, B-9000 Gent, Belgium) under number LMG No. P-32737, LMG No. P-33173 and LMG No. P-33175.

Other preferred strains are strain SKN (DSM 14677; accessible to the public-Leibniz Institute DSMZ-German Collection of Microorganisms and Cell Cultures) and strain BN6 (DSM 6383; accessible to the public-Leibniz Institute DSMZ-German Collection of Microorganisms and Cell Cultures).

These strains can for example be grown in the well-known Reasoner's 2A (R2A) medium or in a liquid rich medium (R medium) that contains for 1 liter of distilled water: 10 g peptone, 5 g yeast extract, 5 g malt extract, 5 g bacto-casamino acids, 2 g beef extract, 2 g glycerol and 1 g MgSO₄ as described previously (Hamana et al. (2015) Int. J. Syst. Evol. Microbiol. 51, 1405-1417). Sphingobium xenophagum strains with accession number LMG No. P-32737, LMG No. P-33173 and LMG No. P-33175 but also strain SKN (DSM 14677) and strain BN6 (DSM 6383) can be incubated at 28° C. with 100 rpm shaking for 3 days in R medium. Bacterial pellets can be recovered by culture medium centrifugation at 4000 G for 10 min. Pellets can rinsed with 0.05M Kalium Phosphate Buffer plus 0.05% Tween 80 (KPBT), centrifuged again and then resuspended in KPBT. Concentration of the suspensions can be determined by spectrophotometer set at 600 nm and adjusted to 1×10⁹ cfu/ml in KPBT. The strains can be stored at −80° C. in 0.85% NaCl sterile water plus 25% glycerol.

Inventors surprisingly observed that the use of Sphingobium xenophagum as a biological control agent according to the disclosure shows improved results in terms of efficacy, in particular in soilless cultures but also in non-soilless cultures. It was observed that bacteria of the species Sphingobium xenophagum in particular Sphingobium xenophagum with accession number LMG No. P-32737, LMG No. P-33173 and LMG No. P-33175 but also strain SKN (DSM 14677) and strain BN6 (DSM 6383) are more efficient for protecting plants against pests by reducing disease incidence and symptoms as compared to conventionally used biological control agents, as well as compared to chemical fungicides.

It should be highlighted that although numerous research groups have demonstrated growth inhibition of plant pests by various rhizosphere isolates in vitro, these results are not predictive of actual biological control activity in vivo, i.e. for treating or preventing a disease caused by the pest in a plant. Among the in vitro screening methods commonly used to screen antagonist activity of a candidate isolate against a pathogen, one can cite the dual plate culture system (Raymaekers et al. (2020) Biol Control. 144, 104240) or the two-clamp VOCs assay, TCVA (Cernava et al. (2015) Front Microbiol. 6, 398). They are commonly used because they allow screening of many isolates at the same time with minimum space needed. However, the skilled person knows that these results are not predictive of the complexity of an in vivo biological control activity for treating or preventing a disease caused by the pest in a plant. Indeed, there are many factors which can influence the biological control activity of a microbial agent in planta including the surrounding environment, the plant itself (its microbiome or its genome for example), the variability of the pest aggressiveness over time, the timing and conditions of the treatment. For example, the temperature and humidity at which an in vitro antagonistic assays is performed can be drastically different from those at which a given plant can grow or a seed can germinate. These differences alone would explain why positive antagonism in vitro cannot as such predict antagonistic activity in more complex systems including plant hosts.

Furthermore, Sphingomonas, and in particular Sphingobium xenophagum, are present in the root microbiota of several crop species, in particular the lettuce root microbiota. Given its natural presence in the root microbiota, Sphingobium xenophagum can be safely utilized without the risk of introducing non-native, invasive species. In addition, in contrast to several bacterial species that have been used in the prior art for preventing plant diseases, Sphingobium xenophagum does not pose a potential risk for the environment and the end users. The biological control agent of the disclosure therefore also provides a safer solution for the treatment or prevention of diseases in plants or seeds.

In a preferred embodiment of the disclosure, the Sphingobium xenophagum used as a biological control agent is a Sphingobium xenophagum with accession number LMG No. P-32737.

In another preferred embodiment of the disclosure, the Sphingobium xenophagum used as a biological control agent is a Sphingobium xenophagum with accession number LMG No. P-33173.

In another preferred embodiment of the disclosure, the Sphingobium xenophagum used as a biological control agent is a Sphingobium xenophagum with accession number LMG No. P-33175.

In another preferred embodiment of the disclosure, the Sphingobium xenophagum used as a biological control agent is a Sphingobium xenophagum with accession number (culture collection number) DSM 14677.

In another preferred embodiment of the disclosure, the Sphingobium xenophagum used as a biological control agent is a Sphingobium xenophagum with accession number (culture collection number) DSM 6383. Advantageously, according to the present disclosure, the Sphingobium xenophagum is chosen in the group consisting of Sphingobium xenophagum with accession number LMG No. P-32737, Sphingobium xenophagum with accession number LMG No. P-33173, Sphingobium xenophagum with accession number LMG No. P-33175, Sphingobium xenophagum with accession number (culture collection number) DSM 14677, Sphingobium xenophagum with accession number (culture collection number) DSM 6383, and mixtures thereof.

Preferably, the Sphingobium xenophagum according to the disclosure does not cause a plant disease. The skilled person is well aware how to select Sphingobium xenophagum bacteria that do not cause a plant disease. In addition, the absence of causing any significant plant disease is easily determined, e.g. by incubating a plant with the Sphingobium xenophagum of choice and determining if a disease arises after a few days.

Advantageously, the Sphingobium xenophagum according to the disclosure is used as a biological control agent for treating or preventing a disease in a plant or seed in need thereof.

The term «plant», in the sense of the present disclosure, is to be understood as including wild-type plants and plants which have been modified by either conventional breeding, mutagenesis, genetic engineering or by a combination thereof. It is also understood that, within the context of the present disclosure, the term «plant» includes both the whole plant as well as a plant part. Non-limiting examples of plant parts include roots, leaves, stems and fruits.

The term «seed», in the sense of the present disclosure, is to be understood as including seeds and plant propagules of all kinds. Non-limiting examples include true seeds, seed pieces, suckers, corms, bulbs, tubers, grains, cuttings and the like.

The term «plant or seed in need thereof», in the sense of the present disclosure, is to be understood as any plant or seed which is healthy or which has been diagnosed with a disease or symptoms thereof, or which is susceptible to a disease, or which may be exposed to a disease or mediator thereof.

An important observation is that the biological control action of Sphingobium xenophagum can be observed at different plant development stages, namely during seed germination and during plant growth. This advantage is beneficial for the culture of plants in rotation, where plants of various developmental stage can be present in the same culture environment.

Advantageously, the plant disease to be treated or prevented is a root disease. It was observed that the protective effect of Sphingobium xenophagum against root diseases could not only reduce plant mortality, but also reduce the symptoms of the root disease at different levels, i.e. decrease root rot symptoms as well as limit foliar fresh mass decrease.

The disease to be treated or prevented according to the disclosure can be mediated by any type of pest. Preferably, the pest is selected from the group consisting of fungi, oomycetes, bacteria, viruses, viroids, virus-like organisms, protists, protozoa, nematodes, insects and parasitic plants. In a preferred embodiment, said pest is selected from the group consisting of oomycetes, ascomycetes, basidiomycetes, myxomycetes, zygomycetes and bacteria. In a further embodiment, said pest is selected from:
Oomycetes, such as
i) Downy mildew such as from the genus Phytophthora, e.g. Phytophthora infestans, Phytophthora cinnamomi, Phytophthora fragariae, from the genus Peronospora, e.g. Peronospora parasitica, Peronospora pisi, Peronospora belbahrii, from the genus Pseudoperonospora, e.g. Pseudoperonospora cubensis, from the genus Bremia, e.g. Bremia lactuae, or from the genus Plasmopara, e.g. Plasmopara viticola;
ii) from the genus Pythium, e.g. Pythium aphanidermatum, Pythium ultimum, Pythium oligandrum, Pythium irregulare, Pythium dissotocum, Pythium graminicola, Pythium spinosum;
Ascomycetes, such as
i) Powdery mildew such as from the genus Podosphaera, e.g. Podosphaera xanthii, Podosphaera fusca, Podosphaera macularis, from the genus Blumeria, e.g. Blumeria graminis, from the genus Erysiphe;
ii) Molds such as from the genus Botrytis, e.g. Botrytis cinerea, from the genus Penicillium, e.g. Penicillium expansum, Penicillium italicum, Penicillium digitatum, Penicillium citrimim, from the genus Aspergillus, e.g. Aspergillus falvus, Aspergillus fumigatus, Aspergillusoryzae, from the genus Cladosporium, e.g. Cladosporium cucmerimim, Cladosporium elegans;
iii) from the genus Septoria, e.g. Septoria apiicola, Septoria tritici, Septoria lycopersici;
iv) from the genus Alternaria, e.g. Alternaria brassicicola, Alternaria solani, Alternaria alternata;
v) from the genus Colletotrichum, e.g. Colletotrichum gloeosporioides, Colletotrichum capsici, Colletotrichum graminicola, Colletotrichum coccodes, Colletotrichum musae, Colletotrichum fragariae;
vi) from the genus Sclerotinia, e.g. Sclerotinia sclerotiorium, Sclerotinia minor, Sclerotinia major;
vii) from the genus Fusarium, e.g. Fusarium oxysporum, Fusarium solani, Fusarium graminearum;
viii) from the genus Verticillium, e.g. Verticillium dahlia;
ix) from the genus Rhizoctonia, e.g. Rhizoctonia solani, Rhizoctonia cerealis;
x) from the genus Thielaviopsis, e.g. Thielaviopsis basicola;
xi) from the genus Cercospora, e.g. Cercospora beticola, Cercospora arachidicola;
xii) from genus Didymella, e.g. Didymella lycopersici;
xiii) from the genus Venturia, e.g. Venturia inaequalis, Venturia pyrina;
xiv) from the genus Phoma, e.g. Phoma lingam;
XV) From the genus Pleospora, e.g. Pleospora betae;
Basidiomycetes, such as
i) Blight such as from the genus Uromyces, e.g. Uromyces beticola, Uromyces phaseoli, from the genus Puccinia, e.g. Puccinia recondite, Puccinia striiformis, Puccinia porri, Puccinia alli or from the genus Tranzschelia, e.g. Tranzschelia pruni, Tranzschelia discolor;
Myxomycetes, such as
i) from the genus Plasmodiophora, e.g. Plasmodiophora brassicae;
Zygomycetes, such as
i) from the genus Mucor, e.g. Mucor circinelloides;
ii) from the genus Rhizopus, e.g. Rhizopus stolonifera;
Bacteria, such as
i) from the genus Ralstonia, e.g. Ralstonia solanacearum;
ii) from the genus Xanthomonas, e.g. Xanthomonas campestris, Xanthomonas citri, Xanthomonas oryzae;
iii) from the genus Clavibacter, e.g. Clavibacter michiganensis;
iv) from the genus Erwinia, e.g. Erwinia amylovora;
v) from the genus Pseudomonas, e.g. Pseudomonas syringae;
vi) from the genus Xylella, e.g. Xylella fastidiosa.

In a preferred embodiment, the pest belongs to the Oomycetes. In a particular embodiment, the pest is selected from the genera Pythium, Phytophthora, Peronospora, Pseudoperonospora, Bremia and Plasmopara; more in particular, the pest is selected from the group consisting of Pythium aphanidermatum, Pythium ultimum, Pythium oligandrum, Pythium irregulare, Pythium dissotocum, Pythium graminicola, Pythium spinosum, Phytophthora infestans, Phytophthora cinnamomi, Phytophthora fragariae, Peronospora parasitica, Peronospora pisi, Peronospora belbahrii, Pseudoperonospora cubensis, Bremia lactuae and Plasmopara viticola. In a more particular embodiment, the pest is Pythium aphanidermatum.

The Sphingobium xenophagum according to the disclosure can be used as a biological control agent for treating or preventing a disease in a plant which can be an ornamental plant or in a crop plant. Advantageously, said plant is a crop plant. Preferably, the crop plant is selected from the Solanaceae, e.g. tomato, potato, eggplant or pepper, the Asteraceae, e.g. lettuce, chicory or sunflower, the Brassicaceae, e.g. rapeseed or cabbage, the Chenopodiaceae, e.g. beet or spinach, the Apiaceae, e.g. carrot, fennel, parsley, celery or coriander, the Rosaceae, e.g. strawberry, apple, the Poaceae, e.g. wheat, barley or corn, the Cucurbitaceae, e.g. cucumber, zucchini, pumpkin or melon, the Fabaceae, e.g. beans or pea, the Alliaceae, e.g. onion, leek or garlic or the Lamiaceae, e.g. mint or basil. In a preferred embodiment, the crop plant belongs to the Asteraceae. More in particular, the crop plant is lettuce.

The aforementioned properties of Sphingobium xenophagum make this microorganism an excellent choice as a biological control agent in a wide range of culture systems, including soil-based culture systems and soilless culture systems.

Inventors have surprisingly observed that Sphingobium xenophagum is particularity suited for use as a biological control agent not only in crops but also in a soilless culture system, such as hydroponics or aquaponics, in contrast with commercially available biological control agents which have been isolated from soil and show poor adaptation and efficacy to the specific aquatic conditions of soilless culture systems.

By the term «soilless culture», is meant in the sense of the present disclosure, a method of growing plants in any medium other than soil which is suitable for growing plants.

By the term «soilless culture system», is meant in the sense of the present disclosure, any artificial means of providing plants with water and nutrients. Soilless culture systems can further comprise a substrate to provide physical support for the plants. Examples of soilless culture systems include hydroponics and aquaponics. While hydroponics generally refers to systems for growing plants by using water-based mineral nutrient solutions, aquaponics refers to an integrated system that combines aquaculture (fish production) and hydroponic plant production in the same recirculated water loop.

Advantageously, as explained above, within the context of the disclosure Sphingobium xenophagum is used as a biological control agent in a soilless culture system, preferably in hydroponics or aquaponics. Sphingobium xenophagum has been found to be particularity suitable for protecting plants grown in soilless culture systems against pests, even more potent than the EPA registered biological control agent Pseudomonas chlororaphis Tx-1. In fact, Sphingobium xenophagum has been identified in the root zone of plants grown in soilless culture systems.

Although not wishing to be bound by theory, it appears that Sphingobium xenophagum is capable of protecting plants against root diseases in soilless systems by another means than through the emission of volatile organic compounds (VOCs). Indeed, whereas VOCs are of great importance in their capacity to act as plant pest suppressors in the phyllosphere or in soil-based agricultural systems, these compounds are generally poorly water-soluble and cannot efficiently diffuse in water-based soilless culture systems such as hydroponics or aquaponics. This may cause Sphingobium xenophagum to be particularity well-suited for use as a biological control agent for treating or preventing root diseases in soilless culture systems.

It is believed that Sphingobium xenophagum confers protection to plants through a variety of mechanisms, including plant pathogen parasitism, antibiosis, plant defense elicitation, and through competitive exclusion of pathogens.

In a particular embodiment of the disclosure, Sphingobium xenophagum is supplied directly to a plant or seed in need thereof, meaning that the Sphingobium xenophagum is applied directly to a seed, a whole plant or a plant part, typically the foliage, stem or roots.

In another particular embodiment, Sphingobium xenophagum is supplied indirectly to the plant or seed in need thereof, meaning that Sphingobium xenophagum is applied to the locus on which the plant or seed is growing or may grow such that the supplied bacteria can preferably come into contact with said plant or seed. Non-limiting examples of such locus include the soil, the substrate surrounding the plant or seed, and the nutrient solution. Preferably Sphingobium xenophagum is applied to the soilless substrate composition surrounding the plant or seed or to the soilless substrate composition on which the plant or seed will be grown. Non-limiting examples of soilless substrate compositions include rockwool, perlite, and cocos.

In another preferred embodiment, Sphingobium xenophagum is supplied to the nutrient solution, preferably the hydroponic or aquaponic nutrient solution in which the plants are grown or will be grown.

Among the suitable manners for supplying Sphingobium xenophagum to the plant or seed, mention can notably be made of spraying (such as aerial spraying or ground spraying), atomizing, vaporizing, drenching, watering, squirting, pouring, fumigating, injecting, painting, seed treating, coating, immersing, soaking and the like by conventional equipment such as a handpump, a backpack sprayer, a boom sprayer, and the like.

Within the context of the present disclosure, Sphingobium xenophagum can be supplied in a solid form or in a liquid form.

In a particular embodiment, Sphingobium xenophagum is supplied in a solid form. Non-limiting examples of suitable solid forms include: powders, dusts, tablets, pellets or granular forms such as granules, microcrumbs and regular crumbs or mixtures thereof. Desired solid forms include granular forms.

According to a preferred embodiment of the present disclosure, Sphingobium xenophagum is supplied in a liquid form. Non-limiting examples of liquid forms include: solutions, dispersions such as emulsions and suspensions, and foams.

The concentrations, volumes, and durations for the supply of Sphingobium xenophagum may vary depending on the type of plant or seed and can be determined by one skilled in the art. However, preferably, Sphingobium xenophagum, as detailed above, is supplied at least at a concentration of between 102 and 1012 CFU, preferably between 106 and 1010 CFU per plant or seed.

In another particular embodiment of the disclosure, the Sphingobium xenophagum is supplied to a plant or seed in need thereof in combination with at least one further biological control agent. In a particular embodiment, the at least one further biological control agent is a bacteria or a fungus.

It is understood that Sphingobium xenophagum, as described herein, can be supplied to a plant or seed in need thereof as a single dose exposure or in multiple dose exposures at different times.

In a particular embodiment, Sphingobium xenophagum, as described herein, is supplied to a plant or seed in need thereof one or more times during the growing cycle of the target plant. For example, in one embodiment, Sphingobium xenophagum is supplied to a plant or seed in the spring at the start of the growing season and/or in the fall at the end of the growing seasons. In one embodiment, Sphingobium xenophagum is supplied to a plant before harvest of plant parts, such as 1 week, 2 weeks, 3 weeks or 4 weeks before the harvest of the plant part. In a yet further embodiment Sphingobium xenophagum is supplied to a plant or seed post-harvest.

The present disclosure further pertains to a method for treating or preventing a plant disease, wherein said method comprises supplying to a plant or seed in need thereof an effective amount of Sphingobium xenophagum, preferably Sphingobium xenophagum with accession number LMG No. P-32737 or with accession number LMG No. P-33173 or with accession number LMG No. P-33175 or with accession number (culture collection number) DSM 14677 or with accession number (culture collection number) DSM 6383, or mixtures thereof.

Advantageously, according to the method of the present disclosure, Sphingobium xenophagum is chosen in the group consisting of Sphingobium xenophagum with accession number LMG No. P-32737, Sphingobium xenophagum with accession number LMG No. P-33173, Sphingobium xenophagum with accession number LMG No. P-33175, Sphingobium xenophagum with accession number (culture collection number) DSM 14677, Sphingobium xenophagum with accession number (culture collection number) DSM 6383, and mixtures thereof.

Generally, all aspects of the present disclosure discussed herein in the context of the use of Sphingobium xenophagum as a biological control agent apply mutatis mutandis to a method for treating or preventing plant disease, as defined above, comprising supplying to a plant or seed in need thereof an effective amount of Sphingobium xenophagum, as defined above.

The present disclosure also provides biological control compositions comprising Sphingobium xenophagum that are suitable for supplying an effective amount of the bacteria according to the disclosure to a plant or seed in need thereof.

It is understood that all definitions and preferences, as described above, equally apply to all further embodiments, as described below.

The inventors have found that biological control compositions comprising Sphingobium xenophagum, as detailed above, are particularity suitable for treating or preventing a disease in a plant or seed in need thereof.

Therefore, the present disclosure further pertains to a substrate composition, a nutrient composition and a plant control composition comprising Sphingobium xenophagum, preferably Sphingobium xenophagum with accession number LMG No. P-32737 or with accession number LMG No. P-33173 or with accession number LMG No. P-33175 or with accession number (culture collection number) DSM 14677 or with accession number (culture collection number) DSM 6383, or mixtures thereof.

Advantageously, for a biological control composition according to the present disclosure, Sphingobium xenophagum is chosen in the group consisting of Sphingobium xenophagum with accession number LMG No. P-32737, Sphingobium xenophagum with accession number LMG No. P-33173, Sphingobium xenophagum with accession number LMG No. P-33175, Sphingobium xenophagum with accession number (culture collection number) DSM 14677, Sphingobium xenophagum with accession number (culture collection number) DSM 6383, and mixtures thereof.

In a particular embodiment, the biological control composition is a soilless substrate composition. Non-limiting examples of soilless substrate compositions include rockwool, perlite, peat, cocos or a combination thereof.

In another particular embodiment, the biological control composition is a hydroponic nutrient composition or an aquaponic nutrient composition.

In a further particular embodiment, the biological control composition is a plant control composition comprising a botanically acceptable carrier, preferably a liquid, aqueous carrier such as water. The plant control composition can be formulated as an emulsifiable concentrate, suspension concentrate, dilute emulsion, directly sprayable or dilutable solution, coatable paste, dilute emulsion, wettable powder, dispersible powder, dust, granule or capsule. Preferably, the plant control composition is selected from a powdered formulation and an aqueous formulation.

Advantageously, the plant control composition may further comprise at least one additional ingredient to enhance the appearance, storage, transport, handling and/or performance of the plant control composition. Preferably, the additional ingredient is a non-naturally occurring ingredient.

In some embodiments, the plant control composition comprises one or more of a stabilizing agent, a moisture absorbing agent, an attracting agent, a carrier, and/or an anti-caking agent.

In a particular embodiment, the plant control composition comprises a stabilizing agent. The stabilizing agent serves to prevent or minimize decay, breaking down, or activation of the bacteria prior to supply to the plant or seed. Examples of stabilizing agents include particulate calcium silicate.

In another particular embodiment, the plant control composition comprises a moisture absorption agent. The moisture absorption agent serves to absorb moisture from the formulation in order to keep the formulation relatively dry and to prevent caking or clumping of the formulation. Examples of moisturizing agents include dessicants, such as particles or beads of silica gel, and super absorbent polymers, such as sodium polyacrylate. Further examples of moisture absorption agents include wood shavings, and clay balls.

In another particular embodiment, the plant control composition comprises an attracting agent. The attracting agent may help to attract the formulation to plants and/or seeds. For example, the attracting agent may have a net positive electrostatic charge, so that it is electrostatically attracted to plants and/or seeds, which have a net negative electrostatic charge. In some examples, the attracting agent may include a mineral, or a mixture of minerals. In one particular example, the attracting agent may include a mineral mixture which includes one or more of the following minerals: silicon dioxide, aluminum oxide, calcium, iron, magnesium, potassium, sodium, phosphorus, titanium, manganese, strontium, zirconium, lithium, rubidium, boron, zinc, vanadium, chromium, copper, yttrium, nickel, cobalt, gallium, cesium, scandium, tin and molybdenum. In another example, the attracting agent may comprise calcium limestone.

In another particular embodiment, the plant control composition comprises a carrier. The carrier may be a suitable starch or flour. The carrier may be selected so that it does not absorb significant amounts of moisture, so that the carrier does not clump. Examples of carriers which may be suitable include corn flour, and grain flours such as rye, wheat, rice flour, and spelt flour. In alternate examples, the carrier may be kaolin. In other examples the carrier may comprise milk powder or talc.

In yet another particular embodiment, the plant control composition comprises an anti-caking agent. One particular example of an anti-caking agent is magnesium oxide. Other anti-caking agents known those skilled in the art may also be employed in the formulations described herein.

In yet another particular embodiment, the biological control composition may further comprise an additional active ingredient, such as plant defense inducer compounds, biological control agents, nutritional elements, fertilizers, pesticides and the like. Preferably, the biological control composition comprises a further biological control agent, more preferably said biological control agent being a bacteria or a fungus.

The skilled person will appreciate that the concentration of Sphingobium xenophagum according to the disclosure in the biological control composition may vary depending on the conditions in which the composition is to be used (e.g. climate, target plant, environment, method of supplying the composition to the plant or seed, etc.).

The methods to manufacture the plant control composition are also an aspect of the present disclosure. It is further understood that all definitions and preferences, as described above, equally apply for all further embodiments, as described below.

The plant control composition of the present disclosure can be prepared by a variety of methods known in the art.

In one embodiment of the present disclosure, the method for the manufacture of the plant control composition, as detailed above, comprises intimate admixing of the Sphingobium xenophagum as described above and one or more of a stabilizing agent, a moisture absorbing agent, an attracting agent, a carrier, and/or an anti-caking agent, as detailed above, into a homogeneous mixture.

It is understood that the skilled person in the art will carry out said intimate admixing according to general practice such as notably using optimal times, speeds, weights, volumes and batch quantities.

It is further understood that the Sphingobium xenophagum may be introduced in the form of a suspension, concentrate, emulsion or paste, however, it may also be present in a solid form such as a powders, pellets or granules to manufacture the plant control composition.

The present disclosure further pertains to a method for treating or preventing a plant disease, wherein said method comprises supplying the biological control composition comprising Sphingobium xenophagum as described herein to a plant or a seed in need thereof. For example, the biological control composition of the disclosure can be used as a prophylactic agent for preventing a disease in a plant or a seed, particularity a disease mediated by a pest of the genus Pythium.

The present disclosure further provides a method for treating or preventing a disease in a plant or seed in need thereof, the method comprising treating a batch of seeds with the plant control composition described herein and then culturing the treated seeds into plants.

These and other embodiments of the disclosure are indicated in the appended claims. The disclosure will now be further described with reference to the following examples, which show non-limiting embodiments of different aspects of the disclosure.

### EXAMPLES

### Example 1: Strains Isolation, Media and Growth Conditions

Bacterial strains have been isolated from aquaponic lettuce rhizoplane. Lettuce plants for fresh rhizoplane isolation were grown in the PAFF box aquaponic system of Gembloux Agro-Bio Tech, University of Liège (Belgium) as described previously (Stouvenakers et al. (2020) Microorganisms 8, 1-25). Rhizoplane water was collected by root sonication for 10 min in a 0.05 M kalium phosphate buffer plus 0.05% Tween 80 (KPBT). Growth rooms were set at a day/night photoperiod of 18/6 h at 23° C. or 28° C. for all isolation protocols and incubating periods.

The newly identified Sphingobium xenophagum strains according to the disclosure have been deposited with the Belgian Coordinated Collections of Microorganisms (BCCM, K. L. Ledeganckstraat 35, B-9000 Gent, Belgium) under numbers LMG No. P-32737, LMG No. P-33173 and LMG No. P-33175.

The identity of each strain was confirmed by sequencing PCR amplified 16S rDNA. DNA extractions were carried out from bacterial cells resuspended in sterile Milli-Q water. The FastDNA Spin Kit with TC cell lysis solution (MP Biomedicals, Illkirch-Graffenstaden, France) was used to start with, from 200 μl of suspension. As described in Stouvenakers et al. (First study case of microbial biocontrol agents isolated from aquaponics through the mining of high-throughput sequencing data to control Pythium aphanidermatum on lettuce. Microbial ecology, 5 Nov. 2022), 16S rDNA was amplified using Forward primer 16S A1 and Reverse primer 16S B1. PCR mixtures were prepared using the MangoTaq™ DNA Polymerase kit (Bioline, London, UK) manual. Thermocyclers were run with an initial denaturation step at 94° C. for 2 min, followed by 30 cycles of 94° C. for 1 min, 50° C. for 1 min, 70° C. for 2 min, and a final extension step at 72° C. for 10 min. The PCR products were purified with QIAquick PCR Purification Kit (QIAGEN Benelux B.V., Antwerp, Belgium) before Sanger sequencing with the same primers at Macrogen Europe B.V. (Amsterdam, The Netherlands). Sequences were assembled using CAP3 program (Huang and Madan (1999) Genome Res. 9, 868-877) and quality trimmed using Chromas software (http://technelysium.com.au/wp/chromas). The edited sequences were annotated by BLASTN analysis against the rRNA/ITS database using NCBI website (www.ncbi.nlm.nih.gov/blast) for closest identification with 97% identity minimum.

### Example 2: Effect of Different Sphingobium xenophagum Strains on the Control of Lettuce Damping Off Mediated by P. aphanidermatum Using Different Seed Treatment Methods

### In Vivo Screening

In order to identify isolates capable of controlling lettuce damping off mediated by Pythium aphanidermatum, an in vivo screening assay was developed. Two different methods of seed treatment were tested in an experimental design set up using 96-well microplates.

Organic pelleted seeds of lettuce (Lactuca sativa) var. Lucrecia RZ (Rijk Zwaan, Merksem, Belgium) were used in 96-well microplates (Greiner Bio-One B.V.B.A., Vilvoorde, Belgium) at a density of one seed by well. One microplate column (8 wells) corresponded to one replicate. Two methods were tested to treat seeds in relation to P. aphanidermatum inoculation: pre-inoculation and biopriming (i.e., pre-inoculated seeds whose germination was stabilized over time). Whatever the method, the seeds were treated with 10 μl of isolate suspension per seed on day 0 (see next section for the preparation of isolate suspensions).

For the pre-inoculation and biopriming treatments, oospores of the pathogen were added 3 days later. After the pre-inoculation treatment, microplates were directly sealed with self-adhesive film. For biopriming, the seed pellets were left to dry under a laminar flow hood for 30 min before sealing. Whatever the method, the microplates were sealed after P. aphanidermatum inoculation with a self-adhesive film that was punctured with a needle above each well to allow air exchange. The microplates were incubated at 23° C. Dark conditions were set before pathogen inoculation (i.e., only for the pre-inoculation and biopriming treatments), and a day/night photoperiod of 18/6 h was set afterward. Seven days after P. aphanidermatum inoculation, seed damping off was binary scored. Dead seeds were scored 0, while healthy seeds with emerged cotyledons were scored 1. At the end of the screening assay, a strain was considered efficacious when a germination rate threshold of 37.5% or 12.5% was reached in pre-inoculation or biopriming, respectively.

Different Sphingobium xenophagum strains with accession number LMG No. P-32737 (Identification reference: PB-30), LMG No. P-33173 (Identification reference: PB-31) and LMG No. P-33175 (Identification reference: PB-33), were tested along with four controls in each microplate at a configuration of 1 column (8 seeds) per control. Negative control (C−) seeds were treated with KPBT buffer and inoculated with the sucrose+Tween solution used for the oospore suspension. Positive control (C+) seeds were treated with KPBT buffer and inoculated with oospores. Fungicide control (Cf) seeds were treated with Proplant® (722 g/l propamocarbe) at a concentration of 0.1% in KPBT buffer and inoculated with oospores. Bio-fungicide control (Cpc) seeds were treated like the tested isolates with Pseudomonas chlororaphis Tx-1 suspension (ATCC 55670 from the American Type Culture Collection) and inoculated with oospores.

Production of P. aphanidermatum Inoculuzm

Sterile 150-ml Erlenmeyer flasks containing 25 ml of clarified V8 CaCO₃ broth (800 ml distilled water, 200 ml V8 juice, 3 g CaCO₃) were inoculated with 5-mm PDA culture plugs of P. aphanidermatum (CBS 132490) grown at 23° C. with 18 h/6 h lighting for 3 days. The flasks were closed with a cotton ball and incubated at 23° C. with 18 h/6 h lighting for 9 days. Each mycelial bulk was recovered and rinsed by vortexing in a 50-ml centrifuge tube filled with 15 ml of sterile distilled water. The operation was repeated at least twice until V8 colour loss. Each mycelium bulk was cut in 2 pieces, and each half was incubated at 28° C. with lighting for 24 h in a 50-ml centrifuge tube filled with 30 ml of sterile distilled water. The mycelium pieces were recovered and mixed for 3 s 8 times with a hand blender (Braun Minipimer Control Plus, 300 w) in a sterile solution containing 10 mM sucrose and 0.05% Tween 20 in distilled water. A proportion of at least one mycelium piece for 12.5 ml of solution was used with a minimum volume of 100 ml. The resulting propagule suspension was filtered through sterile cheesecloth to harvest the oospores, which were counted on a haemocytometer. The concentration was set at 1×10⁴ oospores/ml.

### Strains Culture and Suspension

Bacteria were grown on solid R2A medium at 28° C. for 3 days. Cultures were harvested in KPBT buffer by surface scratching. Bacterial suspensions were diluted to reach 0.825±0.025 absorbance at 600 nm. An absorbance of 0.800 equaled to 5.107 CFU/ml for P. chlororaphis Tx-1. When cultures were not concentrated enough, they were centrifuged at 3000 rpm for 10 min and set to the right concentration after discarding the supernatant. In addition to a first screening at a concentration of 0.825±0.025 absorbance units, different Sphingobium xenophagum strains with accession number LMG No. P-32737 (PB-30), LMG No. P-33173 (PB-31) and LMG No. P-33175 (PB-33) were tested. The strain Sphingobium xenophagum with accession number LMG No. P-32737 (PB-30) as well the bio-fungicide control (Cpc) were tested at a 10-fold concentration (PB-30 10× and Cpc 10× respectively).

### Results

The different Sphingobium xenophagum strains were found to be efficacious to control seed damping-off, both following pre-inoculation and following biopriming as shown in Table 1 below. The suffix “10×” was used to indicate 10× concentrated treatments. C−, C+, Cf and Cpc/Cpc10× were the negative, positive, fungicide and biofungicide controls respectively.

The different bacterial isolates/bacterial strains of Sphingobium xenophagum according to the disclosure were the following:
Sphingobium xenophagum with accession number LMG No. P-32737 (PB-30/PB-30 10×);
Sphingobium xenophagum with accession number LMG No. P-33173 (PB-31); and
Sphingobium xenophagum with accession number LMG No. P-33175 (PB-33).

TABLE 1
Germination rate means of treated seeds with different
S. xenophagum strains to control P. aphanidermatum damping-
off depending on pre-inoculation or biopriming method.

Mean germination rate (%)

| Treatment | Pre-inoculation | Biopriming |
|---|---|---|
| C− | 60.0 | 93.5 |
| C+ | 29.1 | 0.0 |
| Cf | 25.2 | 6.4 |
| Cpc | 12.0 | 7.0 |
| Cpc 10x | 15.6 | 28.1 |
| PB-30 | 51.0 | 18.8 |
| PB-30 10x | 50.0 | 37.5 |
| PB-31 | 53.6 | 27.7 |
| PB-33 | 53.1 | 16.7 |

Following pre-inoculation, the different S. xenophagum strains were found efficacious to control seed damping-off, whereas Cf and Cpc/Cpc10× were not efficacious (germination rate threshold of 37.5%). At a standard concentration (OD=0.825±0.025), the different Sphingobium xenophagum strains allowed for a mean seed germination rate of more than 50%.

Following biopriming, the different S. xenophagum strains also proved efficacious with a mean germination rate superior to threshold of 12.5% at standard concentration. When a 10× suspension was used for the strain PB-30, the mean germination rate increased up to 37.5% following treatment. Once again, the Cf and Cpc/Cpc10× were not efficacious against seed damping-off.

### Example 3: Efficacious Use of Sphingobium xenophagum as a Biological Control Agent

### Treatment and Controls

Sphingobium xenophagum with accession number LMG No. P-32737 (PB-30) was tested against root rot disease mediated by P. aphanidermatum on lettuce seedlings along with four controls. Controls used were a negative healthy control without the pathogen (C−), a positive control (C+), a biopesticide control (Cpc) and a fungicide control (Cf). C+ and C− were treated with KPBT. For Cf, Proplant® (722 g/l propamocarbe) fungicide was used at 0.1% in KPBT buffer. Finally, P. chlororaphis Tx-1 (ATCC 55670, an EPA registered biocontrol agent) suspension was used for Cpc.

In order to validate the reproducibility of the in vivo screening, two different assays were performed with bacteria grown on different media and inoculated at different densities. These are referred to as “Example 3A” and “Example 3B” herein after.

### Strain Culture and Suspension for Example 3A

Bacteria were grown on solid R2A medium at 28° C. for 3 days. Cultures were harvested in KPBT buffer by surface scratching. Bacterial suspensions were measured to reach 0.825±0.025 absorbance at 600 nm and then 10-fold concentrated for lettuce inoculation. A 10-fold concentration of P. chlororaphis Tx-1 equaled to 5.108 CFU/ml. When cultures were not concentrated enough, they were centrifuged at 3000 rpm for 10 min and set to the right concentration after discarding the supernatant.

### Strain Culture and Suspension for Example 3B

The bacteria were produced in liquid rich medium (R medium) that contained in 1 l of distilled water: 10 g peptone, 5 g yeast extract, 5 g malt extract, 5 g bacto-casamino acids, 2 g beef extract, 2 g glycerol and 1 g MgSO₄. Bacteria were incubated à 28° C. with 100 rpm shaking for 3 days. Bacterial pellets were recovered by culture medium centrifugation at 4000 G for 10 min. Pellets were rinsed with 0.05M Kalium Phosphate Buffer plus 0.05% Tween 80 (KPBT), centrifuged again and then resuspended in KPBT. Concentration of the suspensions were determined by spectrophotometer set at 600 nm and adjusted to 1×10⁹ cfu/ml in KPBT.

### Pathogen Inoculum Preparation

As described above for the seed damping-off trials (Example 2), stock mycelial culture of Pythium aphanidermatum (CBS 132490) was first reactivated on PDA for 3 days at 23° C. with a day/night photoperiod of 18 h/6 h. Then, mycelial plugs of the active growing fungus were grown in Erlenmeyer flasks containing 25 ml of clarified V8 CaCO₃ broth (800 ml of distilled water, 200 ml of V8 juice, and 3 g of CaCO₃). After 9 days at the same conditions, mycelial bulk were recovered and rinsed several times in sterile distilled water. Mycelium bulks were then incubated for 24 h at 28° C. with lighting in sterile distilled water to initiate oospores formation and maturation. Mycelium bulks were then mixed with a hand blender (Braun Minipimer Control Plus, 300 w) in a sterile solution containing 10 mM of sucrose and 0.05% of Tween 20 in distilled water. Oospores in suspension were then separated from other propagules by sterile cheesecloth filtration. Oospores found in the filtrate were then set at a concentration of 1×10⁴ oospores/ml after haemocytometer observation.

### Biological Control Experimental Setup

Organic lettuce seeds were sown in 25×25×40 mm rockwool plugs (Grodan B. V., Roermond, Holland) and randomly placed in a phytotron, with a day/night photoperiod of 16 h/8 h, 22° C./18° C. (day/night), and a relative humidity of 65% for the first 10 days of germination as described previously (Stouvenakers et al. (2020) Microorganisms 8, 1-25). Plugs were put in square plant trays of 14 cm side and trays were then randomly placed in a phytotron set at 16 h/8 h (day/night) photoperiod, a temperature of 22° C./18° C. (day/night), and a relative humidity of 65%. Tap water was used for the first week of germination and then hydroponic solution was used instead according to manufacturing instruction (Hy-Pro A and B, Hy-Pro Fertilizers, Bladel, Holland). Ten days after sowing, temperatures and humidity were increased to 35/25° C. (day/night) and 92%, respectively. Treatments were applied at a rate of 1 ml per plug on days 0 and 7. For each treatment, 2 plant trays were used containing each 9 rockwool plugs. On day 10 after sowing, plugs were inoculated by 1 ml of the pathogen suspension, excepted for C− where sucrose+tween solution was used instead. Lettuce mortality (LM), root rot symptoms (RRR: root rot rating) and foliar fresh mass (FFM) were recorded on day 31 as described previously (Stouvenakers et al. (2020) Microorganisms 8, 1-25).

### Results

Sphingobium xenophagum was found to efficiently reduce lettuce mortality (see Table 2), but also to decrease root rot symptoms and to limit foliar fresh mass decrease in comparison with C+ and Cpc controls (Table 3).

TABLE 2
Lettuce mortality (LM) of treatments applied to control
P. aphanidermatum disease on lettuce seedlings.

LM
Lettuce mortality (%)

| Treatment | Example 3A | Example 3B |
|---|---|---|
| C− | 0.0 | 0.0 |
| C+ | 33.3 | 11.1 |
| Cf | 0.0 | 0.0 |
| Cpc | 0.0 | 33.3 |
| PB-30 | 0.0 | 0.0 |

TABLE 3
Root rot rating (RRR) and foliar fresh mass (FFM) of treatments applied
to control P. aphanidermatum disease on lettuce seedlings.

| | RRR | | FMM | |
|---|---|---|---|---|
| | Root rot rating | | Foliar fresh mass | |
| | (0-7) | | (mg) | |
| Treatment | Example 3A | Example 3B | Example 3A | Example 3B |
| C− | 0.22 | 0.56 | 1328.8 | 1844.9 |
| C+ | 6.28 | 6.06 | 677.2 | 1100.4 |
| Cf | 4.50 | 2.17 | 1083.6 | 1726.2 |
| Cpc | 3.72 | 6.06 | 1033.7 | 788.2 |
| PB-30 | 2.17 | 4.67 | 1536.1 | 1341.0 |

When using either the culture and suspension conditions of Example 3A or 3B, Sphingobium xenophagum was found to decrease root rot symptoms and to limit foliar fresh mass decrease in comparison with C+ and Cpc controls (Table 3).

Under Example 3B conditions, although low lettuce mortality (LM) was observed for C+, disease was present with a root rot rating (RRR) of 6.06 and foliar fresh mass (FFM) of 1100.4 mg for this positive control. In comparison, RRR and FFM or C− were 0.56 and 1844.9 mg, respectively. Cf control was effective to reduce RRR (2.17) and no substantial FFM decrease was observed compared with C−. However, Cpc, the biopesticide control, was not able to control the disease, with a RRR of 6.06 and a FFM mean of 788.2 mg.

On the other hand, Sphingobium xenophagum (PB-30) was found to efficiently reduce lettuce mortality, but also to decrease root rot symptoms (RRR=4.67) as well as foliar fresh mass decrease (FMM=1341.0 mg) in comparison with C+ and Cpc.

The results were even more positive under Example 3A conditions. Indeed, Sphingobium xenophagum (PB-30) was found to efficiently reduce lettuce mortality, but also to decrease root rot symptoms (RRR=2.17) and limit foliar fresh mass decrease (1536.1 mg) at a higher extent that the Cf control, thereby demonstrating that this bacterial species is a robust and potent biological control agent.

### Example 4: Use of Sphingobium xenophagum at Different Concentrations to Control Lettuce Seed Damping-Off Caused by Pythium aphanidermatum in Soil

### Microorganisms Preparation

Two different concentrations of Sphingobium xenophagum strain PB30 (LMG No. P-32737) were tested in this experiment to control lettuce damping-off caused by the pathogen Pythium aphanidermatum. From a stock suspension conserved at −80° C. in 25% glycerol, bacterial cells were first reactivated by culturing them on R2A medium for 4 days at 23° C. with a day/night photoperiod of 18 h/6 h. Then, single colonies were used to inoculate new R2A Petri dishes. After one day of incubation at 30° C. in the dark, cultures were harvested by surface scratching in 0.05-M kalium phosphate buffer plus 0.05% Tween 80 (KPBT). Bacterial suspensions were measured at 600 nm in a spectrophotometer and adjusted to reach 5.107 or 5.108 CFU/ml.

Stock mycelial culture of P. aphanidermatum (CBS 132490) conserved in paraffin oil was first reactivated on PDA for 3 days at 23° C. with a day/night photoperiod of 18 h/6 h. Then, second cultures were made from the first and incubated for 5 days under the same conditions. Mycelial plugs were then used as an inoculum source in this experiment.

### Experimental Setup, Treatments, and Pathogen Inoculation

Organic pelleted seeds of lettuce (Lactuca sativa) var. Lucrecia RZ (Rijk Zwaan, Merksem, Belgium) were sowed (one seed by cell) in 28 by 50 cm plug trays of 160 cells (Pöppelmann, Lohne, Germany) containing breeding ground (La Plaine Chassart, Fleurus, Belgium). Plug trays were cut into smaller square trays of 5 by 4 cells and put in square plastic trays of 14 cm. Each cell was separately treated with 2 ml of treatment. Treatments were either a suspension of S. xenophagum strain PB30 at 5.107 or 5.108 CFU/ml. For positive (C+, i.e., with the pathogen) and negative (C−, i.e., without the pathogen) controls, KPBT was used as treatment. Forty cells were treated for each treatment. Then, C+ cells and PB30 treated cells were top inoculated with 4 mm Ø circular mycelial plugs harvested with a cork borer in actively growing cultures of the damping-off pathogen P. aphanidermatum (see microorganisms preparation). Plant trays were placed in a phytotron set at a temperature of 23° C., a relative humidity of 88%, and a day/night photoperiod of 16 h/8 h for 6 days until fully emerged lettuce cotyledons. Then, the seed germination rate was measured per line of 5 cells.

### Results

At both concentrations, lettuce sowed in cells treated by S. xenophagum strain PB30 were less impacted by damping-off caused by P. aphanidermatum than the positive control (Table 4). When cells were treated by strain PB30 at 5.107 CFU/ml, the germination rate was increased from 40% (C+) to 77.5%. At 5.108 CFU/ml, the germination rate increased from 40% (C+) to 55.0%. Thus, corresponding to an additional germination rate of 37.5 and 15% for PB30 treatments at 5.107 and 5.108 CFU/ml, respectively.

TABLE 4
Mean germination rates of lettuce seeds depending on the treatment
applied to control P. aphanidermatum damping-off.

| | Mean germination |
|---|---|
| Treatment | rate (%) |
| C− | 97.5 |
| C+ | 40.0 |
| PB30 at 5.10⁷ CFU/ml | 77.5 |
| PB30 at 5.10⁸ CFU/ml | 55.0 |

### Example 5: Comparison of the Biocontrol Efficacy of Sphingobium xenophagum to Control Lettuce Seed Damping-Off Caused by Pythium aphanidermatum in Soil with a Chemical Fungicide and a Microbial Biofungicide

### Microorganisms Preparation

The damping-off pathogen Pythium aphanidermatum (CBS 132490) and the bacteria Sphingobium xenophagum strain PB30 (LMG No. P-32737) were reactivated, cultivated, and prepared according to the previous experiment. However, only one suspension at a 5.107 CFU/ml concentration of S. xenophagum strain PB30 was prepared.

### Experimental Setup, Treatments, and Pathogen Inoculation

Organic pelleted seeds of lettuce (Lactuca sativa) var. Lucrecia RZ (Rijk Zwaan, Merksem, Belgium) were sowed in plug trays filled with breeding ground as before. Each cell in square plug trays (prepared and displayed as before) was separately treated with 2 ml of treatment. Treatments were, respectively, a suspension of S. xenophagum strain PB30 at 5.107 CFU/ml (i.e., PB30 treatment), Proplant® fungicide (722 g/l propamocarb) at a concentration of 0.1% in water (Proplant® treatment), and Trianum-PR microbial bio-fungicide (1.10⁹ CFU/g Trichoderma harzianum T-22) at a concentration of 0.5 g/l in water (Trianum-P® treatment). For positive (C+, i.e., with the pathogen) and negative (C−, i.e., without the pathogen) controls, KPBT was used as treatment. Eighty cells were treated for each treatment. Then, treated and C+ cells were top inoculated with 4 mm Ø circular mycelial plugs harvested with a cork borer in actively growing cultures of the damping-off pathogen P. aphanidermatum (see microorganisms preparation). Plant trays were placed in a phytotron set at the same conditions as before for 6 days until fully emerged lettuce cotyledons. Then, the seed germination rate was measured per line of 5 cells.

### Results

Lettuce sowed in cells treated by S. xenophagum strain PB30 were less impacted by the damping-off caused by P. aphanidermatum than the positive control (Table 5). Compared with C+, the germination rate of cells treated by the strain PB30 increased from 63.7% to 75.0% respectively. Trianum-PR treatment did not reduce damping-off. The germination rate of C+ and Trianum-PR treatments were 63.7% and 61.2%, respectively. Proplant® treatment gave the best results with a germination rate of 88.7% and then a decrease of the damping-off rate of 25.0%, against 11.2% for PB30.

TABLE 5
Mean germination rates of lettuce seeds depending on the treatment
applied to control P. aphanidermatum damping-off.

| | Mean germination |
|---|---|
| Treatment | rate (%) |
| C− | 100.0 |
| C+ | 63.7 |
| PB30 | 75.0 |
| Proplant ® | 88.7 |
| Trianum-P ® | 61.2 |

### Example 6: Use of Different Sphingobium xenophagum Strains to Control Lettuce Seed Damping-Off Caused by Pythium aphanidermatum in Soil

### Microorganisms Preparation

Three different strains of the bacteria Sphingobium xenophagum were tested in this experiment to control lettuce damping-off caused by Pythium aphanidermatum. They were strain PB30 (LMG No. P-32737), strain SKN (DSM 14677) and strain BN6 (DSM 6383). The damping-off pathogen P. aphanidermatum (CBS 132490) and the 3 strains of S. xenophagum were reactivated, cultivated, and prepared according to the previous experiment. The concentration of the bacterial suspensions was set at 5.107 CFU/ml for all three strains.

### Experimental Setup, Treatments, and Pathogen Inoculation

Organic pelleted seeds of lettuce var. Lucrecia were sowed in plug trays filled with breeding ground as before. Each cell in square trays (prepared and displayed as before) was separately treated with 2 ml of treatment. The treatments were PB30, SKN and BN6 for the 3 strains of S. xenophagum applied at 5.107 CFU/ml, respectively. For positive (C+, i.e., with the pathogen) and negative (C−, i.e., without the pathogen) controls, KPBT was used as treatment. Eighty cells were treated for each treatment. Then, treated and C+ cells were top inoculated with 4 mm Ø circular mycelial plugs harvested with a cork borer in actively growing cultures of the damping-off pathogen P. aphanidermatum (see microorganisms preparation). Plant trays were placed in a phytotron set at the same conditions as before for 6 days until fully emerged lettuce cotyledons. Then, the seed germination rate was measured per line of 5 cells.

### Results

Among the three strains of S. xenophagum used to control lettuce seed damping-off caused by P. aphanidermatum, BN6 was the best strain, followed by SNK and PB30 (Table 6). The mean germination rates for these treatments were 92.5%, 86.2%, and 67.5%, respectively, against 60.0% in the positive control. This experiment showed that all strains ordered could reduce the damping-off disease incidence and that the biocontrol activity is related to the bacterial species S. xenophagum and not to a specific strain.

TABLE 6
Mean germination rates of lettuce seeds depending on the treatment
applied to control P. aphanidermatum damping-off.

| | Mean germination |
|---|---|
| Treatment | rate (%) |
| C− | 98.7 |
| C+ | 60.0 |
| PB30 | 67.5 |
| SNK | 86.2 |
| BN6 | 92.5 |

### Example 7: Use of Sphingobium xenophagum Strain PB30 to Control Phytophthora infestans in Tomato Detached Leaf Assay

### Microorganisms Preparation

Sphingobium xenophagum strain PB30 (LMG No. P-32737) was tested in this experiment to control tomato leaf spots produced by the late-blight pathogen Phytophthora infestans. S. xenophagum PB30 was reactivated, cultivated, and prepared according to the previous experiment. The concentration of the bacterial suspension was set at 1.1010 CFU/ml.

Rye agar B (RA) plates were prepared for fungus growth. For 1 L of RA, 60 g of rye flour was boiled in 1 L of water and cheesecloth filtered. Then 20 g of sucrose, 15 g of agar, and 0.05 g of beta-sitosterol were added. The broth volume was brought up to 1 L with distilled water and then autoclaved. Stock mycelial culture of P. infestans strain 22-015 (received from CRA-W collection) was first reactivated on RA plates and incubated at 18° C. in the dark. Then, second cultures in RA were made from the first and incubated for at least 15 days under the same conditions. P. infestans sporangia were harvested in KPBT buffer by surface scratching, cheesecloth filtered, and then counted on a hemocytometer. Suspension at 1.10⁵ sporangia/ml was then prepared for host inoculation.

### Experimental Setup, Treatments, and Pathogen Inoculation

Tomato plants var. Money Maker (Henrion, Huy, Belgium) grew in a greenhouse for 6 weeks were used as vegetal material for P. infestans biocontrol in detached leaf assay. Leaflets of the fourth leaves were sampled on tomato plants. Leaflets were put upside down in humid boxes. Then, the abaxial sides were separately treated by spraying 2 ml of the PB30 suspension (PB30 treatment) or KPBT buffer for the positive control (C+). The test comprised two boxes by treatment, each containing 4 leaflets. Boxes were incubated slightly open at 23° C. without lighting. After 24 h, leaflets abaxial sides were each inoculated with 10 μl of sporangia suspension. Boxes were sealed and incubated for seven days at 18° C. without lighting. After incubation, leaflets were immersed in a mixture of ethanol/methanol at 50/50 volume for 24 h to extract chlorophyll. The width radius (r1) and the length radius (r2) of the leaf spot left by the pathogen were measured. Lesions areas caused by P. infestans were then calculated with the formula π×r1×r2.

### Results

The positive control (C+) showed a P. infestans disease incidence of 87.5% (Table 7). In the mean, lesion areas developed on tomato leaflets of C+ were 125.8 mm². While disease incidence in PB30 treatment was null. Indeed, no symptoms were observed on leaflets treated with S. xenophagum PB30. This result showed that leaf treatment with S. xenophagum can control late-blight infection in tomato plants.

TABLE 7
Disease incidence and mean areas of disease lesions produced by
P. infestans inoculation on tomato leaflets in detached leaf assay.

| | Mean lesions | Disease |
|---|---|---|
| Treatment | areas (mm²) | incidence (%) |
| C+ | 125.8 | 87.5 |
| PB30 | 0.0 | 0.0 |

### Example 8: Use of Sphingobium xenophagum Strain PB30 to Control Alternaria solani in Tomato Detached Leaf Assay

### Microorganisms Preparation

Sphingobium xenophagum strain PB30 (LMG No. P-32737) was tested in this experiment to control tomato leaf spots produced by the early blight pathogen Alternaria solani. S. xenophagum PB30 was reactivated, cultivated, and prepared according to the previous experiment. The concentration of the bacterial suspension was set at 1.1010 CFU/ml.

Stock mycelial culture of A. solani strain 12341 (DSM 62028) was first reactivated on PDA plates and incubated at 23° C. with a day/night photoperiod of 18 h/6 h. Then, second cultures in PDA were made from the first and incubated for at least 14 days under the same conditions. Mycelial plugs were then used as an inoculum source in this experiment.

### Experimental Setup, Treatments, and Pathogen Inoculation

Tomato plants var. Money Maker (Henrion, Huy, Belgium) grew in a greenhouse for 6 weeks were used as vegetal material for A. solani biocontrol in detached leaf assay. Leaflets of the fourth leaves were sampled on tomato plants. Leaflets were put upside down in humid boxes. Then, the abaxial sides were separately treated by spraying 2 ml of the PB30 suspension (PB30 treatment) or KPBT buffer for the positive control (C+). The test comprised one box containing 5 leaflets by treatment. Boxes were incubated slightly open at 23° C. with indirect lighting. After 24 h, leaflets abaxial sides were each inoculated with A. solani mycelial plug of 1 mm Ø harvested with a cork borer. Boxes were sealed and incubated for seven days at 23° C. with indirect lighting. After incubation, the width radius (r1) and the length radius (r2) of the necrotic and chlorotic spots produced by the pathogen were measured. Lesions areas caused by A. solani were then calculated with the formula π×r1×r2.

### Results

Leaf treatment with PB30 suspension reduced early blight symptoms on tomato plants. Indeed, the areas of the necrotic and chlorotic lesions in PB30 treatment were reduced by 78.1% and 59.5%, respectively. In the mean, necrotic and chlorotic lesion areas developed on tomato leaflets of C+ were 212.8 and 616.7 mm², respectively (Table 8). While the area of the necrotic and chlorotic lesions in PB30 treatment was 46.5 and 249.1 mm², respectively. These results showed that leaf treatment with S. xenophagum can decrease early blight infection and colonisation in tomato plants.

TABLE 8
Mean areas of necrotic and chlorotic lesions produced by A. solani
inoculation on tomato leaflets in detached leaf assay.

| | Mean necrotic | Mean chlorotic |
|---|---|---|
| Treatment | lesions areas (mm²) | lesions areas (mm²) |
| C+ | 212.8 | 616.7 |
| PB30 | 46.5 | 249.1 |

1. A use of Sphingobium xenophagum as a biological control agent for controlling a pest population.

2. The use according to claim 1, wherein the Sphingobium xenophagum is chosen in the group consisting of Sphingobium xenophagum with accession number LMG No. P-32737, Sphingobium xenophagum with accession number LMG No. P-33173, Sphingobium xenophagum with accession number LMG No. P-33175, Sphingobium xenophagum with accession number (culture collection number) DSM 14677, Sphingobium xenophagum with accession number (culture collection number) DSM 6383, and mixtures thereof.

3. The use according to claim 1, for treating or preventing a disease in a plant or seed in need thereof.

4. The use according to claim 3, wherein the disease in a plant is a root disease.

5. The use according to claim 3, wherein the disease is mediated by a pest selected from the group consisting of Oomycetes, Ascomycetes, Basidiomycetes, Myxomycetes, Zygomycetes and bacteria.

6. The use according to claim 3, wherein the disease is mediated by a pest of the genus Pythium, preferably Pythium aphanidermatum.

7. The use according to claim 3, wherein the plant or seed is a crop plant, preferably a crop plant selected from the group consisting of Solanaceae, Asteraceae, Brassicaceae, Chenopodiaceae, Apiaceae, Rosaceae, Poaceae, Cucurbitaceae, Fabaceae, Alliaceae and Lamiaceae, preferably Asteraceae, most preferably lettuce.

8. The use according to claim 1, in a soilless culture system, preferably a soilless culture system selected from the group consisting of hydroponics and aquaponics.

9. The use according to claim 1, wherein Sphingobium xenophagum is supplied to a plant or seed in need thereof in combination with at least one further biological control agent.

10. A method for treating or preventing a plant disease, wherein said method comprises supplying to a plant or a seed in need thereof an effective amount of Sphingobium xenophagum.

11. The method according to claim 10, wherein Sphingobium xenophagum is chosen in the group consisting of Sphingobium xenophagum with accession number LMG No. P-32737, Sphingobium xenophagum with accession number LMG No. P-33173, Sphingobium xenophagum with accession number LMG No. P-33175, Sphingobium xenophagum with accession number (culture collection number) DSM 14677, Sphingobium xenophagum with accession number (culture collection number) DSM 6383, and mixtures thereof.

12. The method according to claim 10, wherein Sphingobium xenophagum is supplied to the plant or seed in need thereof by direct application onto soil on which plants are grown, watering, addition to a growth medium, direct application onto the soilless substrate on which plants are grown, application to a seed, and/or foliar spraying.

13. The method according to claim 10, wherein the plant or seed is cultured in a soilless culture system, preferably hydroponics or aquaponics.

14. A biological control composition comprising Sphingobium xenophagum, wherein the composition is selected from the group consisting of: a substrate composition, a nutrient composition and a plant control composition.

15. The biological control composition according to claim 14, wherein Sphingobium xenophagum is chosen in the group consisting of Sphingobium xenophagum with accession number LMG No. P-32737, Sphingobium xenophagum with accession number LMG No. P-33173, Sphingobium xenophagum with accession number LMG No. P-33175, Sphingobium xenophagum with accession number (culture collection number) DSM 14677, Sphingobium xenophagum with accession number (culture collection number) DSM 6383, and mixtures thereof.

16. The biological control composition according to claim 14, wherein the substrate composition is a soilless substrate composition, preferably a soilless substrate composition comprising rockwool, peat, perlite, cocos or a combination thereof.

17. The biological control composition according to claim 14, wherein the nutrient composition is a hydroponic nutrient composition or an aquaponic nutrient composition.

18. The use according to claim 2, for treating or preventing a disease in a plant or seed in need thereof.

19. The use according to claim 4, wherein the disease is mediated by a pest selected from the group consisting of Oomycetes, Ascomycetes, Basidiomycetes, Myxomycetes, Zygomycetes and bacteria.

20. The method according to claim 11, wherein Sphingobium xenophagum is supplied to the plant or seed in need thereof by direct application onto soil on which plants are grown, watering, addition to a growth medium, direct application onto the soilless substrate on which plants are grown, application to a seed, and/or foliar spraying.
